(19) United States
(12) Patent Application Publication
(10) Pub. No.: US 2010/0023733 A1
(43) Pub. Date: Jan. 28, 2010

(54) Microprocessor Extended Instruction Set Precision Mode

(75) Inventors: Charles H. Moore, Sierra City, CA (US); Gregory V. Bailey, Incline Village, NV (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/338,972

(22) Filed: Dec. 18, 2008

Related U.S. Application Data
(63) Continuation-in-part of application No. 12/270,661, filed on Nov. 13, 2008.
(60) Provisional application No. 61/124,174, filed on Apr. 15, 2008.

(51) Int. Cl. G06F 9/302

(52) U.S. Cl. 712/221; 712/E09.017

(57) ABSTRACT

A method and apparatus to gain additional functionality of a microprocessor by adding an extended instruction set mode. In this mode, the result of executing an instruction may be changed without changing the instruction itself. In the extended instruction set mode, there is an increase to the number of bits of precision when executing the plus instruction. An additional bit position is added to the program counter register. When this bit is set, the microprocessor is in extended instruction set mode. In addition, a new one bit latch is provided. The latch may be changed only when the microprocessor is in extended instruction set mode. The latch is defined as holding a true carry bit. A significant bit of a register holding a sum is saved in the carry latch at the end of the plus instruction.

### CROSS-REFERENCE TO RELATED APPLICATIONS

This application claims the benefit of U.S. Provisional Patent Application Ser. No. 61/124,174 entitled “Improvements for a Computer Array Chip”, filed on Apr. 15, 2008, which is incorporated herein by reference in its entirety.

This application is a continuation in part and claims the benefit of co-pending U.S. patent application Ser. No. 12/270,661 entitled “Microprocessor Extended Instruction Set Mode”, filed on Nov. 13, 2008, which is incorporated herein by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of microprocessors and more specifically to increasing functionality while maintaining relative simplicity of reduced instruction set computers.

### BACKGROUND OF THE INVENTION

A reduced instruction set computer (RISC) sacrifices code density to simplify implementation and to increase performance compared to a complex instruction set computer (CISC). The RISC, shown schematically in FIG. 2, has a fixed width for both the instructions as part of the instruction set and the instruction word register executing the instructions. The fixed length instructions typically implement only a single operation such as a bit shift of the contents in a single register or the data transfer from one register to another. In contrast, a CISC instruction set may have variable length instructions and also have variable length instruction words.

An advantage of the RISC is that it can execute instructions faster than equivalent instructions executed by the CISC. However, there is a limit to the possible number of instructions that can fit in the RISC instruction word. Therefore, once the possible bit combinations for instructions have been used, new instructions cannot be added to the instruction word. Nonetheless, regardless of how well designed an instruction set may have been when it was first developed, it may need to be extended. An extension may be in the form of new instructions, a change to one or more existing instructions, or the replacement of an existing instruction with a new instruction. A goal of the extension is to increase the functionality of the RISC while maintaining its speed advantage.

Even if new instructions are somehow added, there is the problem of maintaining the legacy features of the original instructions. There is another problem that adding instructions to increase the functionality of a RISC machine may involve significant manipulation to existing circuitry. Extra or more complex circuitry can lead to greater timing problems, execution errors, and greater power demands. Thus, any time a change is made to the existing transistor layout of a microprocessor, whether this change is in the form of addition or removal of elements, the microprocessor should be retested. This can be a complex and time consuming task.

Therefore, there is a need to change the result of an execution of an instruction by a RISC, without changing the instruction within the instruction set. This can have the benefit of maintaining the same instruction set for the instruction word while increasing functionality. In addition, having this option of executing either version of the same instruction would also maintain legacy features and keep changes in microprocessor circuitry to a minimum.

The goals of maintaining the same instruction set, increasing functionality, maintaining legacy features, and keeping changes in microprocessor circuitry to a minimum are disclosed in U.S. Provisional Patent Application No. 61/124,174. A further goal, the subject of this application, is desirable. That is, increasing the number of bits of precision of one instruction in particular, the “plus” instruction, in extended instruction mode, is a desirable further increase in functionality.

### SUMMARY OF THE INVENTION

A related application, U.S. patent application Ser. No. 12/270,661, which is incorporated herein by reference in its entirety, discloses a method and apparatus to gain additional functionality of a microprocessor, with minimal changes in circuitry, by adding an extended instruction set mode. In this mode, the result of executing an instruction may be changed without changing the instruction itself. This application further discloses an increase to the number of bits of precision when executing a plus instruction (also called an ADD instruction) in the extended instruction set mode.

The microprocessor enters the extended instruction set mode when an address bit is set. An ADD instruction in extended instruction set mode increases the number of bits of precision by means of a carry latch. In this mode, the ADD instruction calculates the sum of three quantities, namely the values of two registers as well as the prior value of the carry latch (interpreted as one or zero). Then the carry latch is reset depending upon the result of the summation. When the microprocessor is not in extended instruction set mode, an ADD instruction does not alter the carry latch.

To be more precise, an additional bit position, e.g. P9, is added to the program counter register (PC or P register). When P9 is set by, for example, jumping to or calling an address with that bit set to one, the microprocessor is in extended instruction set mode. In addition, a new one bit latch is provided. The latch may be changed only when the microprocessor is in extended instruction set mode. The latch is defined as holding a true carry bit as number zero or one.

A single execution of the plus ‘+’ instruction adds the contents of a T-register and an S-register of the data stack and places the result back into the T-register while leaving the S-register unchanged. The T and S registers may, for example, be 18 bits long. In extended instruction set mode, the plus instruction also replaces the T-register with the sum of the T and S registers and of a one bit value representing the state of the carry latch at the beginning of the instruction. Another difference with the non-extended instruction set mode is that in extended instruction set mode the carry bit out of the 18^{th} bit of the T-register is saved in the carry latch at the end of the plus instruction.

Normal addition neither produces nor consumes the carry bit. When exiting the extended instruction set mode, the contents of the carry latch are preserved until the next time an operation that uses it executes in extended instruction set mode. Addition of large numbers in extended instruction set mode is done by adding pairs of 18 bit words of numbers, starting with the low order, so that the carry propagates upward through the sum. The operation begins with carry zero.

Subtraction is done by adding the ones complement (not, or −) of one of the numbers to the other in the same way. In this case, the initial carry is set to one, thus completing the twos complementation of one of the arguments.

The following are examples of ways to obtain the current value of the carry latch:
0 dup.+ Returns 0 or 1, and also clears the carry.
dup dup−.+ Returns −1 if carry was 0, 0 if carry was 1, and leaves carry unchanged.

The following are examples of ways to clear and set the carry latch:
dup or dup.+ Clears carry, burns top stack item.
dup or − dup.+ Sets carry, burns top stack item.
+Clears carry by adding any two throwaway positive values, or any others with sum <3FFFF₁₆.
+Sets carry by adding any two throwaway negative values, or any others whose sum is >3FFFF₁₆. These two boundary conditions are biased so that correct results do not depend on the prior state of the latched carry bit.

The following are examples of implementation of carry operations:
The carry latch is gated into bit 0 of the ALU whenever P9 is set. When it is not set, 0 is gated in.
The carry out of the 18^{th} bit of the ALU is latched by a strobe derived from the one used to latch ALU to T, if and only if P9 is set and the instruction decodes as +.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE FIGURES

The purposes and advantages of the present invention will be apparent from the following detailed description in conjunction with the appended figures of drawings and tables in which:

FIG. 1 is a diagrammatic view of a computer array;

FIG. 2 illustrates the major internal features of one of the cores in FIG. 1;

FIG. 3 is a flow chart depicting the method of executing a plus instruction in one of the cores in FIG. 1;

TBL. 1 shows the possible input bit and input carry combinations to produce a resultant bit and carry out when executing the plus instruction;

FIG. 4 illustrates the major internal features of one of the cores in FIG. 1, specifically with a change to the bit width of a program register (P-register);

FIG. 5 is a flow chart of the method for executing a plus instruction in one of the processors, whose major internal features are shown in FIG. 2, when the instruction is executed in the extended instruction set mode;

TBL. 2 shows the possible input bit, input carry, and input carry bit latch combinations to produce a new carry bit latch when executing the plus instruction in the extended instruction set mode.

In the various figures of the drawings, like references are used to denote like or similar elements or steps.

### DETAILED DESCRIPTION OF THE INVENTION

In the following description and in the accompanying drawings, specific terminology and drawing symbols are set forth to provide a thorough understanding of the present invention. In some instances, the terminology and symbols may imply specific details that are not required to practice the invention.

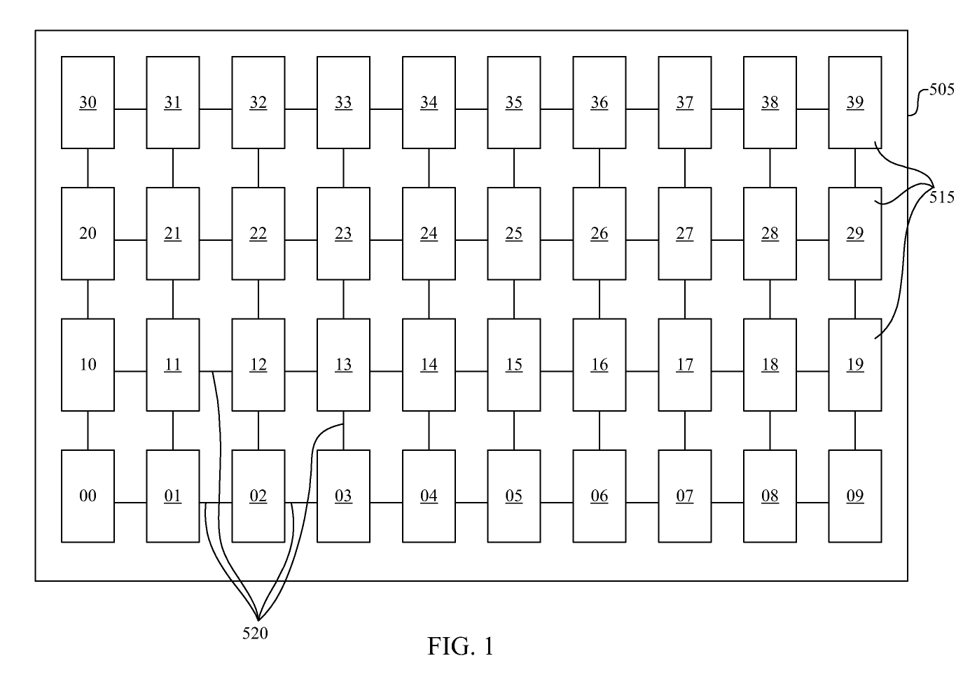

FIG. 1 is a diagrammatic view of a microprocessor 505 having, as an example, a forty member array of computers. Each individual member of this array is sometimes referred to as a “core” or a “node” when the microprocessor 505 is implemented in a single module or on a single semiconductor die. Representative examples of microprocessor 505 cores are computers 515. FIG. 1 shows the array of computers numbered individually 00 to 39. The computers 515 are each a digital processor and interconnected to each other by a plurality of buses, represented by buses 520.

These computers 515 are referred to individually herein in the prior art as a computer core 510a. While microprocessor 505 may be a 40 core array, sold under the registered trademark SEAforth® by IntellaSys® Corporation of Cupertino, Calif., a member of The TPL Group® of companies, this invention is not limited to 40 core microprocessors and equally applies to microprocessors with varying numbers of cores. However, for the sake of example, the following discussion references SEAforth® 40 core microprocessors.

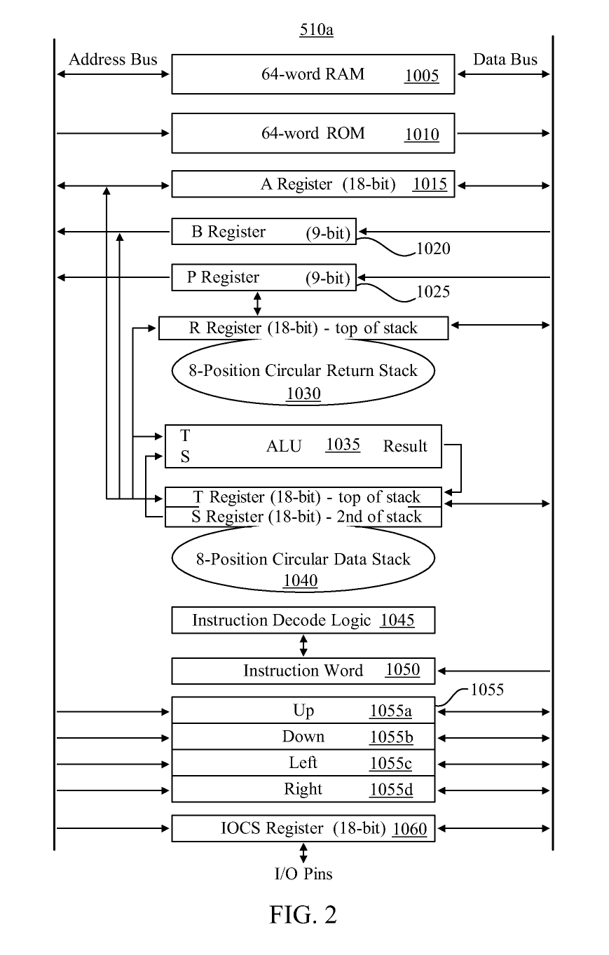

FIG. 2 is a diagrammatic view of internal features of core 510a. It is a digital processor, including a 64-word quantity of random access memory (RAM 1005), a 64-word quantity of read only memory (ROM 1010), an 18-bit variable “A” register (A-register 1015), a 9-bit variable “B” register (B-register 1020), and a 9-bit variable “P” register (P-register 1025). Also included are a return stack 1030 with top element of the return stack labeled R, an arithmetic and logic unit (ALU 1035), and a data stack 1040 with top element of the data stack labeled T and second element of the data stack labeled S. Each element, a part of the return stack 1030 and data stack 1040, is an 18-bit register. An instruction decode logic 1045 decodes an instruction word contained in an instruction word register 1050. An instruction word contains instructions, data, or combinations thereof and is specifically divided into four slots for decode by the logic 1045. Slots 0, 1, and 2 are each five bits wide and are represented by bits 13-17, 8-12, and 3-7, respectively, of the instruction word. Slot 3 is three bits wide and is represented by bits 0-2 of the instruction word. Further included are four communication ports, collectively referred to as ports 1055, and individually as the up port 1055a, the down port 1055b, the left port 1055c, and the right port 1055d, and an 18-bit input/output control and status register (IOCS-register 1060).

A plus ‘+’ instruction is one of thirty machine codes used to control the computer 510a. A single execution of the plus ‘+’ instruction will add the contents of the top element T-register and second element S-register of the data stack 1040, placing the result back into the T-register while leaving the S-register unchanged. The data stack 1040 is not otherwise changed in the execution of the plus instruction.

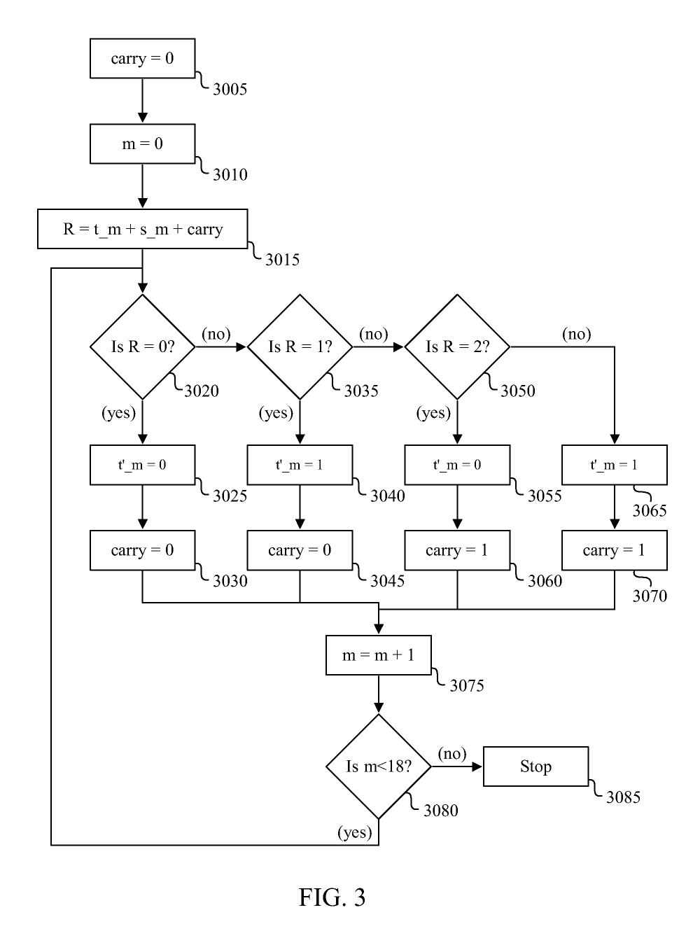

FIG. 3 is a flow chart depicting the method of executing a plus instruction in one of the processors 510a. In the course of describing the bit by bit result of combining the values in the T-register and the S-register, it is often convenient to refer to a bit in the value contained in the T-register prior to the execution of the plus instruction. It is also convenient to refer to a bit in the result which will be latched into the T-register upon the completion of executing the plus instruction. For simplicity, when a reference is made to a bit in the T-register, the reference is made to the bit in the value contained in the T-register prior to the execution of the plus instruction. When a reference is made to a bit in the T′-register, the reference is made to the bit in the value contained in the T-register after the execution of the plus instruction. In step 3005, a carry is set to zero, and in step 3010 a bit index m is set to zero. The bit index m is used to represent individual bits in the T′-register as t′ₘ, the T-register as tₘ, and the S-register as sₘ. Next in step 3015, a comparison value R is computed as the decimal sum of tₘ, sₘ, and the carry. If the comparison value R is ‘0’ in step 3020, then the bit placed in the T′-register at a bit position m, t′ₘ, is ‘0’ in step 3025. Then the carry used for the calculation of the next bit in the T′-register t′ₘ₊₁, is ‘0’ in step 3030. If the comparison value R is ‘1’ in step 3035, then the bit placed in the T′-register at a bit position m, t′ₘ, is ‘1’ in step 3040, and the carry used for the calculation of the next bit in the T′-register is ‘O’ in step 3045. If the comparison value R is ‘2’ in step 3050, then the bit placed in the T′-register at a bit position m, t′ₘ, is ‘0’ in step 3055, and the carry used for the calculation of the next bit in the T′-register is ‘1’ in step 3060. If the comparison value R is not ‘2’ in step 3050, then the bit placed in the T′-register at a bit position m, t′ₘ, is ‘1’ in step 3065, and the carry used for the calculation of the next bit in the T′-register is ‘1’ in step 3070. The bit index m is incremented by one in step 3075. If the bit index m is greater than 17 in step 3080, then the execution of the plus instruction, which latches the resultant value in the T′-register back into the T-register, is complete in step 3085. Otherwise, the process repeats beginning with step 3015 in which a new comparison value R is calculated.

TBL. 1 shows the value which should be placed in a bit position t′m of the T′-register and the carry out from all the possible combinations of a bit tₘ of the T-register, a bit sₘ of the S-register, and the carry into bit m. As shown in the t′m column, the value for t′ₘ is ‘0’ when the total number of bits set to logic high from tₘ, sₘ, and the carry into bit m is zero or two. Conversely, the value for t′ₘ is ‘1’ when the number of bits set to logic high from tₘ, sₘ, and the carry into bit m is one or three. The carry out is ‘0’ when one or zero bits are set to logic high from tₘ, sₘ, and the carry into bit m. The carry out of bit m is ‘1’ when two or more bits are set to logic high from tₘ, sₘ, and the carry into bit m.

Combining a value t in the T-register and a value s in the S-register by executing the plus instruction, as it is illustrated in FIG. 3, does not account or maintain a potential carry out of bit t′ₙ₋₁. For example, if the 18 bit wide T-register and S-register of a single c18 computer each contain the value of $20000, then the execution of the plus instruction places a value of $00000 back into the T-register. Clearly, this is not the correct result. Due to the fact that it is only possible to maintain an 18 bit result or more generally an n bit result when executing the plus instruction, great care should be taken to carefully consider the contents of the T-register and the S-register prior to the execution of the plus instruction. From TBL. 1 it is evident that there are four possible scenarios in which there is a carry out of ‘1’ from bit t′ₙ₋₂. For three of the four cases, this occurs when there is a carry out of ‘1’ as a result of determining bit t′ₙ₋₂ combined with at least one if not both of the bits tₙ₋₁ or sₙ₋₁ containing a value of ‘1’. The fourth and final case for producing a carry out of ‘1’ from bit t′ₙ₋₁ occurs when both bits tₙ₋₁ and sₙ₋₁ have a value of ‘1’ and the carry out from bit t′ₙ₋₂ is ‘0’. Thus, a carry out from bit t′ₙ₋₁, when a value t in the T-register and a value s in the S-register are combined by executing the plus instruction, will not yield the correct result being latched into the T-register.

Therefore, there is a need to modify the instruction so that it can account for a carry out of ‘1’ from bit t′ₙ₋₁. This can have the benefit of allowing for greater precision when adding two values by means of the plus instruction.

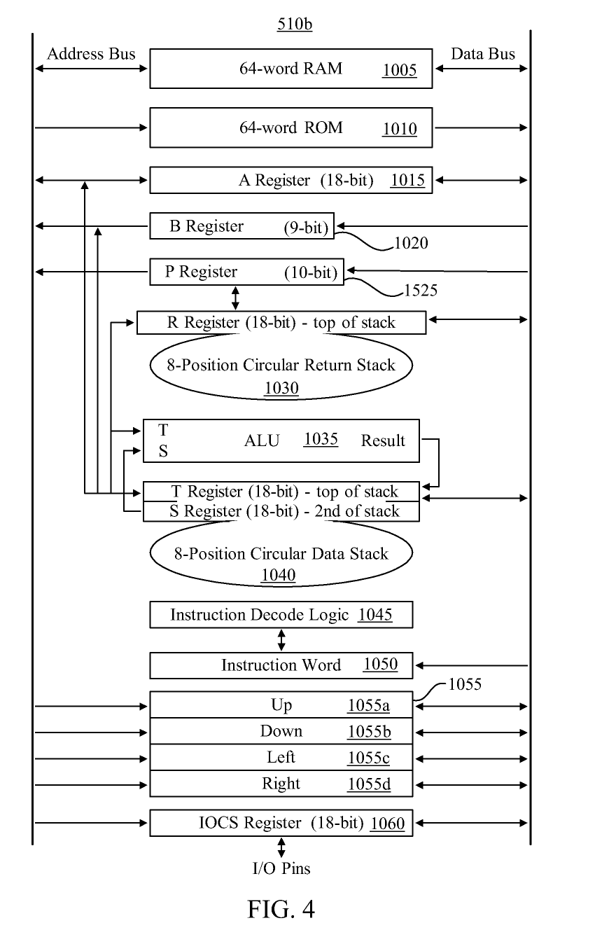

FIG. 4 is a diagrammatic view of internal features of core 510b. A ten bit P-register 1525 is shown as the lone change to the major internal features of core 510a from FIG. 2. The inclusion of a tenth bit in a program counter P-register 1525 indicates the state of the extended instruction set mode. If the tenth bit of the P-register 1525 is set high, the extended instruction set mode is active. Instructions that are executed while the P-register 1525 has its tenth bit set high are executed in the extended instruction set mode. If the tenth bit of the P-register 1525 is set low, the extended instruction set mode is not active. Instructions that are executed while the P-register 1525 has its tenth bit set low are executed in the non-extended instruction set mode.

Executing the plus instruction in the extended instruction set mode utilizes a true carry bit latch in addition to the carry out referenced in the execution of the plus instruction in FIG. 3. The plus with carry instruction both consumes the current carry bit and produces a new setting in the carry bit. Nothing changes the carry latch except execution of a plus instruction in extended mode; add in normal mode does not change whatever state the last add in extended mode left it in.

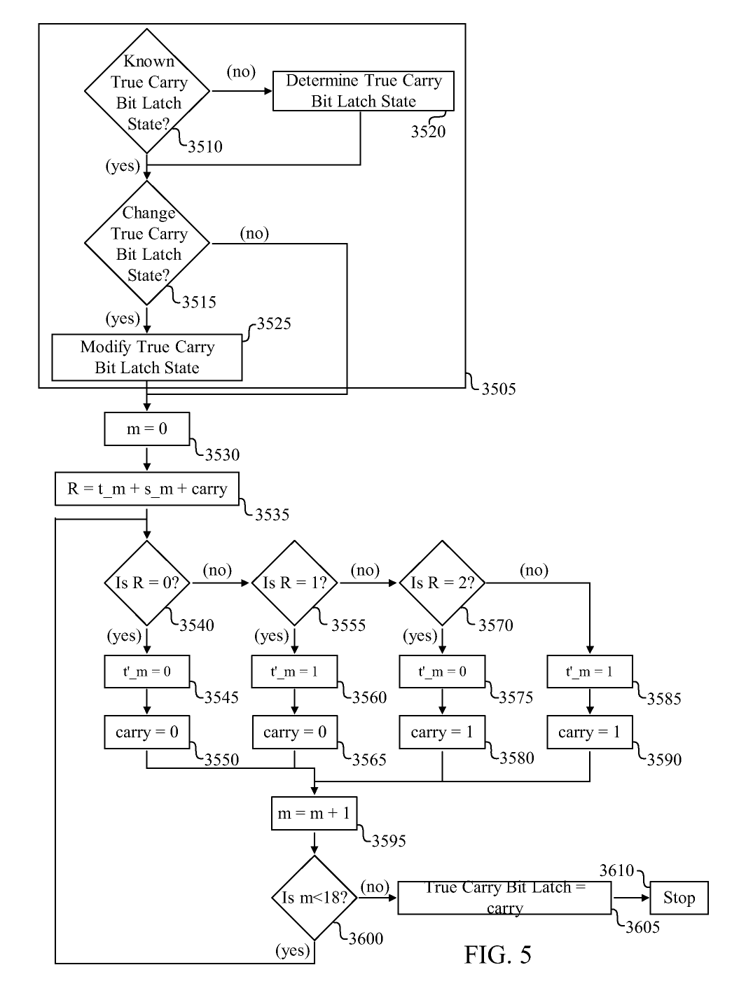

FIG. 5 depicts the execution of the plus instruction in the extended instruction set mode, along with a sub-process 3505 in which the true carry bit latch is determined and/or specified. The first element of the sub-process 3505 is a decision block 3510. If the state of the true carry bit latch is known, then the sub-process moves to a second decision step 3515. Otherwise, in step 3520, the state of the true carry bit latch is determined followed by a transition to the second decision step 3515. If it is necessary to modify the true carry bit latch, then it is modified to the appropriate state in step 3525, which completes the sub-process 3505. If it is not necessary to modify the true carry bit latch, then the sub-process 3505 is complete.

Turning now to the execution of the plus instruction, in the extended instruction set mode a bit index m is initialized to zero in step 3530. Next in step 3535, a comparison value R is computed as the decimal sum of tₘ, sₘ, and the carry. If in step 3540 the comparison value R is ‘0’, then the bit placed in the T′-register at a bit position m, t′ₘ, is ‘0’ in step 3545, and the carry used for the calculation of the next bit in the T′-register is ‘0’ in step 3550. If the comparison value R is ‘1’ in step 3555, then the bit placed in the T′-register at a bit position m, t′ₘ, is ‘1’ in step 3560, and the carry used for the calculation of the next bit in the T′-register is ‘0’ in step 3565. If the comparison value R is ‘2’ in step 3570, then the bit placed in the T′-register at a bit position m, t′ₘ, is ‘0’ in step 3575, and the carry used for the calculation of the next bit in the T′-register is ‘1’ in step 3580. If the comparison value R is not ‘2’ in step 3570, then the bit placed in the T′-register at a bit position m, t′ₘ, is ‘1’ in step 3585, and the carry used for the calculation of the next bit in the T′-register is ‘1’ in step 3590. The bit index m is incremented by one in step 3595. If the bit index m is less than 18 in step 3600, then the execution of the plus instruction repeats beginning with step 3515, in which a new comparison value R is calculated. Otherwise, the true carry bit latch is set to the carry value in step 3605 for use in the execution of the next instruction, which utilizes the true carry bit latch followed by the latching of the resultant value in the T′-register back into the T-register in step 3585, which completes the execution of the plus instruction in the extended instruction set mode.

A comparison between FIG. 3 and FIG. 5 reveals two main differences. The first is with respect to step 3605 of FIG. 5, in which the true carry bit latch is set to the carry out of bit n−1 when combining a value t in the T-register and a value s in the S-register. This step is not a part of FIG. 5, as the true carry bit latch is only available and able to be modified in the extended instruction set mode. The second difference between FIG. 3 and FIG. 5 has to do with the setting of the carry into bit 0 when combining a value t in the T-register and a value s in the S-register. In step 3005 of FIG. 3, the carry into bit 0 is initialized to zero. In the sub-process 3505 of FIG. 5, the true carry bit latch is determined and/or modified to an appropriate value which is then used as the carry into bit 0 for combining a value t in the T-register and a value s in the S-register.

The first difference between FIG. 3 and FIG. 5 indicates that the true carry bit latch is both consumed and set in a single execution of the plus instruction in the extended instruction set mode. If a value t in the n bit T-register is combined with a value s in the n bit S-register via the plus instruction when it is executed in the extended instruction set mode and the result has a most significant bit at a bit position greater than bit n−1, then the true carry bit latch is set to a logic high. In the case of a core of the SEAforth® 40 core microprocessor, where the T-register and S-register are both eighteen bits wide, this implies that a result greater than $3ffff will set the true carry bit latch to logic high, and a value less than or equal to $3ffff will clear the true carry bit latch.

The second stated difference between FIG. 3 and FIG. 5, respectively, indicates that care must be taken to determine and/or modify the state of true carry bit latch prior to executing a plus instruction in the extended instruction set mode. The state of the true carry bit latch is not defined at the initial power on or reset of the SEAforth® 40 core microprocessor. Thus, the state is also unknown upon entering the extended instruction set mode. Therefore, the programmer must either first determine the state of the true carry bit latch and then set the true carry bit latch or first set the state of the true carry bit latch. If the programmer decides to first determine the state of the true carry bit latch, then the programmer will, in approximately half the time as a follow up step, modify the true carry bit latch.

The importance of determining and/or modifying (if needed) the state of the carry bit latch is described next. Recall that the reason the plus instruction has a slightly modified execution in the extended instruction set mode for use in performing extended arithmetic or arithmetic that when performed in the non-extended instruction set mode will not yield the correct result. Still, care must be taken when utilizing the plus instruction in the extended instruction set mode; it is possible that the result of combining two values via plus instruction in the extended instruction set mode will be incorrect, while combining the same two values via the plus instruction in the non-extended instruction set mode would yield the correct result. For example, if the T-register and the S-register of a core of the SEAforth® 40 core microprocessor contain the values $2aaaa and $15555, respectively, the execution of the plus instruction in the non-extended instruction set mode would yield a result of $3ffff in the T-register. On the other hand, executing a plus instruction in the extended instruction set mode with the same initial contents of the T-register and the S-register yields a result $3ffff if the true carry bit latch is set to 0, and a result $00000 if the true carry but latch is set to 1. Clearly, using the plus instruction in the extended instruction set mode inappropriately or without regard to the state of the true carry bit latch can lead to disastrous results.

TBL. 2 summarizes the change to the true carry bit latch when executing a single plus instruction in the extended instruction set mode. The new value of the true carry bit latch, determined as a result of executing a single plus instruction, is based on bit n−1 of the T-register and bit n−1 of the S-register prior to executing the plus instruction, as well as the carry into bit n−1 of the T′-register when executing the plus instruction. Shown in TBL. 2 are the possible combinations of the values contained in the true carry bit latch prior to the execution of the plus instruction, bit 17 of the T-register prior to the execution of the plus instruction, bit 17 of the S-register prior to the execution of the plus instruction, the carry into bit 17 of the T′-register during the execution of the plus instruction, and the new value of the true carry bit latch for each of these possible combinations. As a general rule, the new true carry bit latch is set when two or more of the following have a state of ‘1’, bit 17 of the T-register prior to the execution of the plus instruction, bit 17 of the S-register prior to the execution of the plus instruction, or the carry into bit 17 for use in determining bit 17 of the T′-register during the execution of the plus instruction.

The foregoing description details specific embodiments of the invention, and is included for illustrative purposes. However, it will be apparent to one skilled in the art that many combinations and permutations of the described embodiments are possible while remaining within the scope and spirit of the invention. While various embodiments have been described above, it should be understood that they have been presented by way of example only, and that the breadth and scope of the invention should not be limited by any of the above described exemplary embodiments, but should instead be defined only in accordance with the following claims and their equivalents.

TABLE 1

| | |
|---|---|
| (Input) | (Output) |

| | | Carry into | | | Carry out of |
|---|---|---|---|---|---|
| tₘ | sₘ | Bit m | | t′ₘ | Bit m |
| 0 | 0 | 0 | → | 0 | 0 |
| 0 | 0 | 1 | → | 1 | 0 |
| 0 | 1 | 0 | → | 1 | 0 |
| 0 | 1 | 1 | → | 0 | 1 |
| 1 | 0 | 0 | → | 1 | 0 |
| 1 | 0 | 1 | → | 0 | 1 |
| 1 | 1 | 0 | → | 0 | 1 |
| 1 | 1 | 1 | → | 1 | 1 |

TABLE 2

| (Input) | | | | | (Output) |
|---|---|---|---|---|---|
| True Carry | | | Carry into | | New True Carry |
| Bit Latch | t₇¹ | s₇¹ | Bit 17 | | Bit Latch |
| 0 | 0 | 0 | 0 | → | 0 |
| 0 | 0 | 0 | 1 | → | 0 |
| 0 | 0 | 1 | 0 | → | 0 |
| 0 | 0 | 1 | 1 | → | 1 |
| 0 | 1 | 0 | 0 | → | 0 |
| 0 | 1 | 0 | 1 | → | 1 |
| 0 | 1 | 1 | 0 | → | 1 |
| 0 | 1 | 1 | 1 | → | 1 |
| 1 | 0 | 0 | 0 | → | 0 |
| 1 | 0 | 0 | 1 | → | 0 |
| 1 | 0 | 1 | 0 | → | 0 |
| 1 | 0 | 1 | 1 | → | 1 |
| 1 | 1 | 0 | 0 | → | 0 |
| 1 | 1 | 0 | 1 | → | 1 |
| 1 | 1 | 1 | 0 | → | 1 |
| 1 | 1 | 1 | 1 | → | 1 |

What is claimed is:

1. A method of providing a microprocessor extended instruction set mode and increasing the precision of an addition comprising:
accessing a significant bit of a program counter register;
placing the microprocessor in an extended instruction set mode if the significant bit is set; and,
setting a latch to carry if the microprocessor is in the extended instruction set mode, a plus instruction is executed, and a significant bit of a register holding a sum resulting from execution of the plus instruction is set.

2. The method of claim 1 further comprising steps for accessing a value of the latch.

3. The method of claim 2 further comprising steps for clearing a value of the latch.

4. The method of claim 3 further comprising steps for calculating a result of adding two registers with the value of the latch.

5. The method of claim 4 wherein the value of the latch is not altered when the microprocessor executes instructions and the microprocessor is not in extended instruction set mode.

6. The method of claim 5 wherein the microprocessor comprises one or more RISC cores.

7. A microprocessor comprising:
a program counter register including a significant bit;
means for activating an extended instruction set mode if the significant bit is set; and,
means for setting a latch to carry wherein the latch is set to carry if the microprocessor is in the extended instruction set mode, a plus instruction is executed, and a significant bit of a register holding a sum resulting from executing of the plus instruction is set.

8. The microprocessor of claim 7 further comprising means for accessing a value of the latch.

9. The microprocessor of claim 8 further comprising means for clearing a value of the latch.

10. The microprocessor of claim 9 further comprising means for calculating a result of adding two registers with the value of the latch.

11. The microprocessor of claim 10 wherein the value of the latch is not altered when the microprocessor executes instructions and the microprocessor is not in extended instruction set mode.

12. The microprocessor of claim 11 wherein the microprocessor further comprises one or more RISC cores.

13. A microprocessor comprising:
an extended instruction set mode activated when an address bit is set,
a carry latch,
means for calculating a sum of values of two registers plus a value of the carry latch when in extended instruction set mode, and,
means for resetting the value of the carry latch depending upon the sum wherein the value of the carry latch is not changed if the microprocessor executes instructions when the extended instruction set mode is not activated.

14. A method of increasing the precision of a microprocessor addition comprising:
activating a microprocessor extended instruction set mode when an address bit is set,
providing a carry latch,
steps for calculating a sum of values of two registers plus a value of the carry latch when in extended instruction set mode, and,
steps for resetting the value of the carry latch depending upon the sum wherein the value of the carry latch is not changed if the microprocessor executes instructions when the extended instruction set mode is not activated.
